(19) United States
(12) Patent Application Publication
(10) Pub. No.: US 2023/0020435 A1
(43) Pub. Date: Jan. 19, 2023

(54) WIRE, CONDUIT, AND ELECTRONICS ORGANIZER

(71) Applicant: Six Foot Plus Systems, LLC, Frisco, TX (US)

(72) Inventors: Nathan Robert Huntoon, Frisco, TX (US); Nicholas Sloane Vrana, Seattle, WA (US)

(21) Appl. No.: 17/864,380

(22) Filed: Jul. 13, 2022

Related U.S. Application Data
(60) Provisional application No. 63/221,383, filed on Jul. 13, 2021.

(51) Int. Cl. H02G 3/32; F16L 3/06

(52) U.S. Cl. CPC H02G 3/32; F16L 3/06

(57) ABSTRACT

The present invention provides for an apparatus and a method for holding electric wires, cables, conduits, and the like, and for mounting electronic enclosures, electronic devices, and the like. An arrangement of retaining members extending upwardly from a support base provides one or more channels holding wire or other lengths of material.

### CROSS-REFERENCED APPLICATIONS

This application claims the benefit of the filing date of U.S. Provisional Application No. 63/221,383, filed Jul. 13, 2021, entitled Wire, Conduit, and Electronics Organizer, the disclosure of which is hereby fully incorporated by reference.

### FIELD OF THE INVENTION

The present invention relates to a device and connection management systems and, more particularly, to a modular customizable device and connection management system for managing, holding, and routing electric wires, cables, conduits, and the like, and for mounting and holding electronic enclosures, electronic devices, and the like.

### BACKGROUND OF THE INVENTION

A modular and customizable device and connection management system is provided for managing, hiding, routing, and holding electric wires, cables, conduits, and the like, or for mounting and securing electronic enclosures, devices, and the like, in homes, factories, warehouses, offices, shops, and in any other environment where electric cables and devices may be used. Embodiments of the present invention may be used on desks, entertainment centers, electronics racks, computer cases, work setups, and the like or as the user may desire.

### SUMMARY

Embodiments of the present invention relate to apparatuses and methods for managing, holding, and routing electric wires, cables, conduits, and the like, and for mounting electronic enclosures, electronic devices, and the like.

The various embodiments and examples of the present invention as presented herein are understood to be illustrative of the present invention and not restrictive thereof and are non-limiting with respect to the scope of the invention.

### BRIEF DESCRIPTION OF THE DRAWINGS

For a more complete understanding of the present invention and the advantages thereof, reference is now made to the following Detailed Description taken in conjunction with the accompanying drawings, in which:

FIGS. 1A and 1B show a lateral and a perspective view, respectively, an exemplary embodiment of a retaining member with a dome cap;

FIGS. 2A and 2B show an example of a cable being secured within an embodiment of a retaining cell;

FIGS. 3A and 3B show a top and a perspective view, respectively, of an exemplary embodiment of a plurality of retaining cells arranged in an exemplary square grid layout;

FIG. 4 shows a top view of an exemplary embodiment of a plurality of retaining cells arranged in an exemplary triangular grid layout;

FIG. 5 shows an example of a device being secured on an exemplary embodiment of the retaining cell;

FIG. 6 shows an exemplary embodiment of a retaining cell with a plurality of retaining members having exemplary square caps;

FIGS. 7A and 7B show a top and a perspective view, respectively, of an exemplary embodiment of a retaining cell with a plurality of retaining members having exemplary octagonal caps;

FIG. 8 shows an exemplary embodiment of a retaining cell with a plurality of retaining members having exemplary inverted conical stems and caps;

FIGS. 9A and 9B show a top and a lateral view, respectively, of an exemplary embodiment of a retaining cell with a plurality of retaining members having exemplary caps, stems, and channels of varying sizes;

FIG. 10 shows a top view of an example of a retaining cell formed in an exemplary custom shape; and

FIGS. 11A and 11B show a top and a perspective view, respectively, of an exemplary embodiment of a retaining cell with a plurality of retaining members formed with an exemplary elastomeric block.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, specific details, and the like, have been omitted inasmuch as such details are not considered necessary to obtain a complete understanding of the present invention, and are considered to be within the understanding of persons of ordinary skill in the relevant art.

Embodiments of the present invention relate to a device and connection management systems and, more particularly, to a modular customizable device and connection management system capable of managing, mounting, and routing cables, conduits, electronic enclosures, electronic devices, and the like.

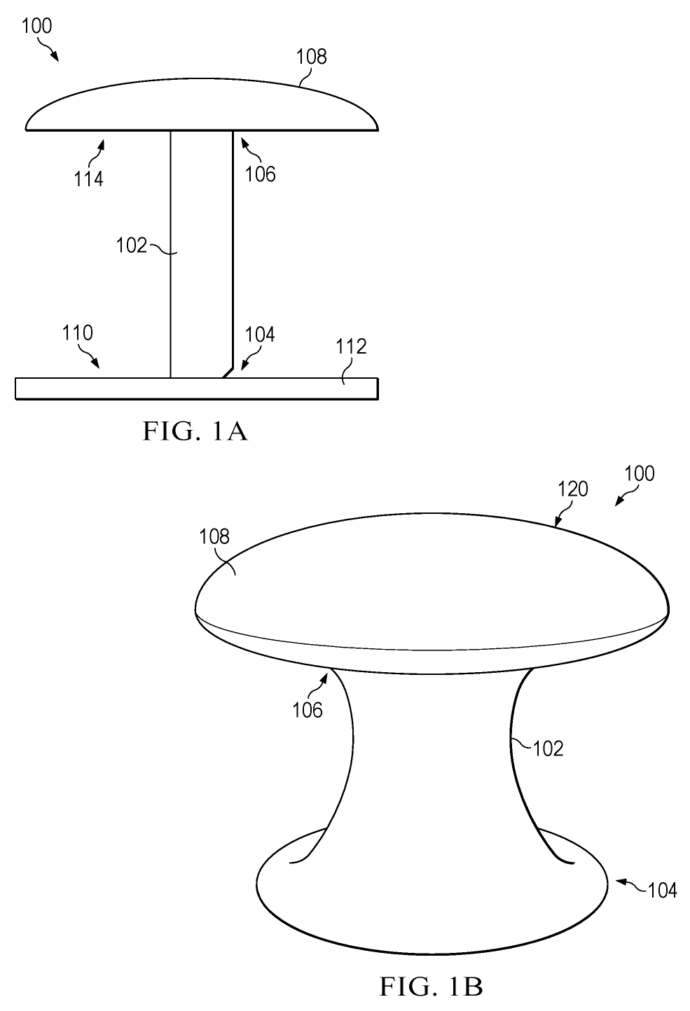

Turning to FIGS. 1A and 1B, the modular device and connection management system may comprise a flexible retaining member 100 formed on a support base 112. In an embodiment, the retaining member 100 may comprise a stem 102 having a proximal end 104 and a distal end 106, and a cap 108 connected to the distal end 106 of the stem 102. The proximal end 104 of the stem 102 may extend from a support surface 110 of the support base 112. The distal end 106 of the stem 102 may be connected to a bottom surface 114 of the cap 108. When the flexible retaining member 100 is on the support base 112, the longitudinal length of the stem 102 may extend between the support base 112 and the cap 108.

In an embodiment, as shown in FIG. 1B, a top surface 120 of the cap 108 may be formed as a rounded dome cap shape. The cross-sectional diameter of the cap 108 may extend a distance greater than the cross-sectional diameter of the stem 102. The retaining member 100 may be formed with a relatively thin stem 102 with flared out features disposed at the proximal and distal ends 104, 106 of the stem such that the proximal and distal ends 104, 106 of the stem 102 may radiate outwards away from a longitudinal axis of the stem 102. The flaring at the ends 104, 106 of the stem 102 may allow the attachment points between the stem 102, the cap 108, and the support base 112 to be formed as fillets. The forming of fillets at the attachment points may distribute and reduce the stress that may be employed on the proximal and distal ends 104, 106 of the stem 102 when the retaining member 100 is in use.

In an embodiment, the retaining member 100 may be formed as a molded flexible part from rubber, plastic, or other hard resin materials that may exhibit elastic or resilient properties such that the retaining member 100 may be manipulated and flexed by an external force, but may also quickly recover and return to its original shape once the external force is removed. In an embodiment, the retaining member 100, flexible stem 102, and/or flexible cap 108 may be formed from materials such as but not limited to rubber, acrylic, polycarbonate, high-density polyethylene, high-density polyethylene, plastic, acrylonitrile butadiene styrene (ABS) plastic, thermoplastic elastomers, thermoplastic polyurethanes, elastic resin, and the like.

In an embodiment, the retaining member 100 may be constructed via injection molding, extrusion, additive manufacturing, and other common rubber, plastic, or silicone manufacturing techniques. The retaining member 100 may be manufactured as a single unitary part or multiple parts that may then each be adhered together. The retaining member 100 may comprise flexible stems 102 and/or flexible caps 108 that may each be separately formed as a molded flexile elastic part and adhered together. In an embodiment, only the cap 108 or only the stem 102 may be flexible in the retaining member 100.

In an embodiment, the support base 112 may be planar, grooved, undulating, tiered in height, mesh, or any other structure that may hold and prevent the stems 102 from movement at their proximal ends 104 on the support base 112.

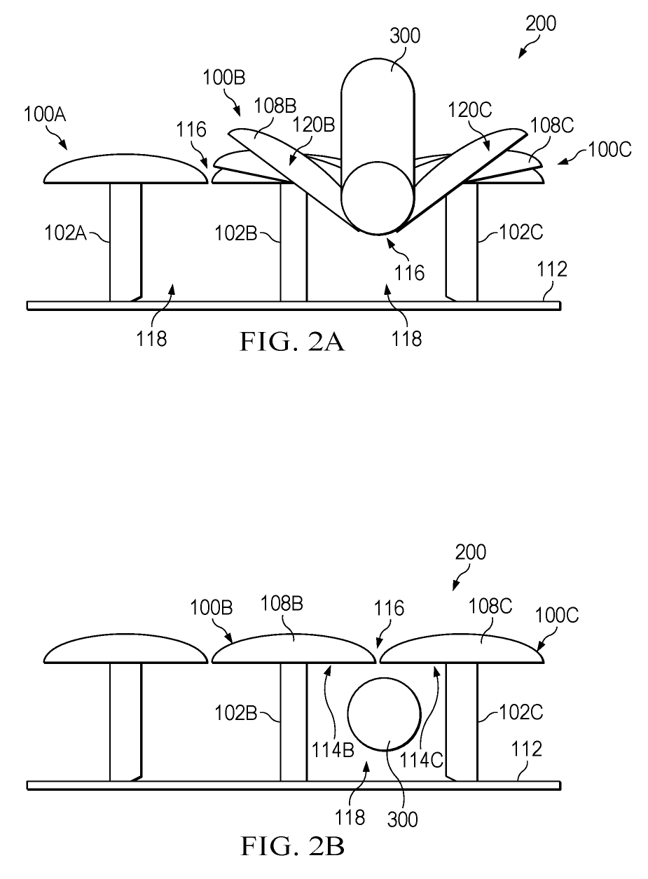

Turning to FIGS. 2A and 2B, a plurality of flexible retaining member 100A-C may extend from the support base 112 to form a retaining cell 200. The retaining cell 200 may comprise two or more retaining members 100 positioned on a single sheet of the support base 112. Adjacent retaining members 100B-C in the retaining cell 200 may cooperate to hold a portion of a wire 300. When the retaining cell 200 is in use to hold the wire 300, the longitudinal lengths of the stems 102B-C of adjacent retaining members 100A-C may laterally confine portions of the wire 300 positioned between them, while the adjacent caps 108B-C of adjacent retaining members 100B-C extending towards one another, and the support base 112, may retain the wire 300 vertically.

In the example of the retaining cell 200 shown in FIG. 2A, three retaining members 100A-C are depicted extending from the support base 112. The retaining members 100A-C in the retaining cell 200 may be positioned with a cap space 116 between each of caps 108A-C of the retaining members 100A-C in the retaining cell 200. The three retaining members 100A-C in the retaining cell 200 may also be positioned with a channel space 118 between each of stems 102 of the retaining members 100A-C.

As shown in FIGS. 2A and 2B, in an embodiment, the cap and channel space 116, 118 in the retaining cell 200 may be sized such that a portion of the wire 300 may be fitted between the adjacent caps 108 of retaining member 100B-C when the caps 108B-C are flexed. The convexly curved top surface 120 of the caps 108B-C may facilitate sliding of the wire 300 toward the perimeter edge of the caps 108B-C and the associated cap space 116 between adjacent caps 108B-C. The caps 108 may be sized extend towards the caps 108 of adjacent retaining members 100 and to fully span, nearly span, or partially span across the channel space 118 between the adjacent retaining members 100. The caps 108 may be configured with sizes and/or shapes that provide confinement of the portion of the wire 300 placed in the channel space 118 between the stems 102 of adjacent retaining members 100.

As shown in FIG. 2A, in an embodiment, to hold the wire 300 between adjacent retaining members 100B-C, the wire 300 may be fitted through the cap space 116 between the caps 108B-C of retaining members 100B-C and set into the channel space 118 between the adjacent stems 102B-C, as shown in FIG. 2B. When seated within the channel space 118 between the adjacent stems 102B-C of retaining members 100B-C, the wire 300 may be adjacent to the support base 112. Alternatively, the wire 300 may be in direct contact and seated against the support base 112. The original width of the cap space 116 may initially be smaller than the diameter of the wire 300 such that a flexing and enlarging of the cap space 116 may be required for the wire 300 to initially fit through the cap space 116 and into the channel space 118. The original size of the cap space 116 may therefore cause the caps 108B-C to also resist the release of the wire 300 from between the adjacent retaining members 100 after the wire 300 is set into the channel space 118.

In an embodiment, when the wire 300 is being fitted through the cap space 116 between retaining members 100B-C, the urging of the wire 300 through the cap space 116 may contact and apply a force against the top surfaces 120B-C of the caps 108B-C of retaining members 100B-C. The urging of the wire 300 against the caps 108B-C through the cap space 116 may deform and flex the caps 108B-C of retaining members 100B-C towards the support base 112 thereby increasing the cap space 116 between retaining members 100B-C. The caps 108B-C on retaining members 100B-C may flex enough in response to the urging of the wire 300 to enable the wire 300 to be fitted through the cap space 116 and set within the channel space 118 between the stems 102B-C of retaining members 100B-C.

When set within the channel space 118 and depending on the diameter of the wire 300 being held, the adjacent stems 102 of the retaining members 100B-C may be contacted and flexed by the placement of the wire 300 within the channel space 118. In an embodiment where the diameter of the wire 300 may be greater than the size of the channel space 118, the stem 102 between adjacent retaining members 100 may flex to accommodate for the larger size of the wire 300 being inserted into the channel space 118. The contact between the wire 300 and the adjacent stems 102, and the elastic property of the stems 102, may then allow the stems 102 to accommodate for the larger size of the wire 300. The flexing of the stems 102 may also assist in resisting the removal of the wire 300 from between the adjacent stems 102.

When the wire 300 is fitted through the cap space 116, the force caused by the urging of the wire 300 against the top surface 120 of the caps 108 may be removed thereby allowing the caps 108B-C on retaining members 100B-C to elastically recover and return to their original position, shape, and size. As shown in FIG. 2B, in an embodiment, when the caps 108B-C of retaining members 100B-C return to their original shape, the cap space 116 may also reduce to its original size smaller than the diameter of the wire 300. The width of cap space 116 may then be smaller than the diameter of the wire 300 such that the wire 300 may be retained in the space adjacent to the bottom surface 114B-C of the caps 108B-C. When the caps 108B-C return to their original position, shape, and size, the caps 108B-C may prevent the wire 300 from re-crossing the cap space 116 absent an additional force that may re-flex or re-deform the adjacent caps 108B-C. When the wire 300 is fitted within the channel space 118, the wire 300 may be “held” between the retaining members 100B-C such that the wire 300 is retained between the support surface 100 of the support base 112 and the bottom surface 114 of the caps 108B-C of retaining members 100B-C, as well as between the stems 102B-C of retaining members 100B-C.

In an embodiment, the wire 300 that may be held by the retaining cell 200 may include cables and conduits including but not limited to electronics cables, power cords, internet cables, video cables, Cat6E cables, audio cables, and the like. The channel space 118 between retaining members 100 may therefore be sized appropriately to hold the alternative wires 300 that may be held by the retaining cell 200.

In an alternative embodiment, the channel space 118 may be a fixed size between retaining members 100 throughout the entire retaining cell 200. Alternatively, the channel space 118 in the retaining cell 200 may vary to allow routing of different wire 300 types. The channel space 118 may also be varied to enable single wire confinement, multiple wire confinement, crossing wires, bending wires, and the like.

The “holding” of the wire 300 between adjacent retaining members 100 and adjacent the support base 112 may allow the wire 300 to be routed and retained in any arrangement against the support base 112 using additional retaining members 100 in the retaining cell 200. Additional adjacent pairs of retaining members 100 may be used in the retaining cell 200 to hold a different portion of the wire 300 in a different position to route the overall extension and path of the wire 300.

In an embodiment, once the wire 300 is set within the channel space 118 between two adjacent retaining member 100s, the wire 300 may be removed from the retaining cell 200 by pulling the wire 300 away from the support base 112. The wire 300 may be released from the channel space 118 by being pulled through the cap space 116 between the caps 108B-C of the adjacent retaining member 100B-C holding the wire 300. When extracting the wire 300, the pulling of the wire 300 against the bottom surface 114 of the caps 108B-C holding the wire 300 may cause the caps 108B-C to flex upwards such that the caps 108B-C may flex away from the support base 112 and increase the width of the cap space 116. The caps 108B-C on retaining members 100B-C may flex enough in response to the urging of the wire 300 to enable the wire 300 to be pulled through the cap space 116 and released from the channel space 118 between retaining members 100B-C.

The retaining cell 200 may be formed with two or more retaining members 100 extending from the support base 112. The plurality of retaining members 100 may be formed on the support base 112 in any arrangement or configuration based on the shape and size of the intended wire 300 to be held and the desired management and routing of the wire 300 by a user. The plurality of retaining members 100 in the retaining cell 200 on the support base 112 may be configured in a variety of shapes and arranged in a variety of arrangements or patterns to enable the wire 300 to be held and routed in a desired path by the retaining cell 200. In an embodiment, the retaining cell 200 may be modular such that more than one retailing cell 200 may be assembled and used together to further hold, manage, and route, one or more wires 300.

In alternative embodiments, the perimeter of the caps 102 of the retaining members 100 may be formed with any variety of polygonal shapes. In an embodiment, a single retaining cell 200 may be formed with a plurality of retaining members 100 each having caps 102 formed with perimeters of different polygonal shapes. In an embodiment, different retaining cells 200 each with different retaining members 100 may also be used together.

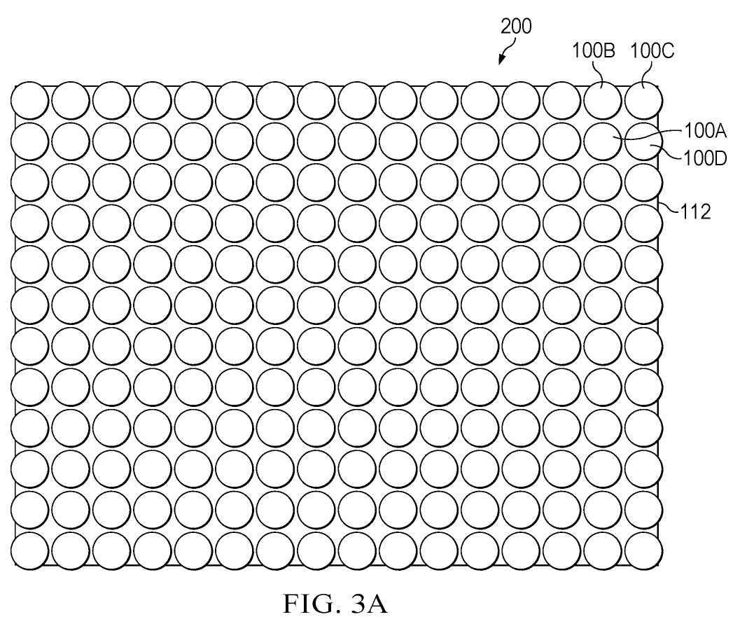

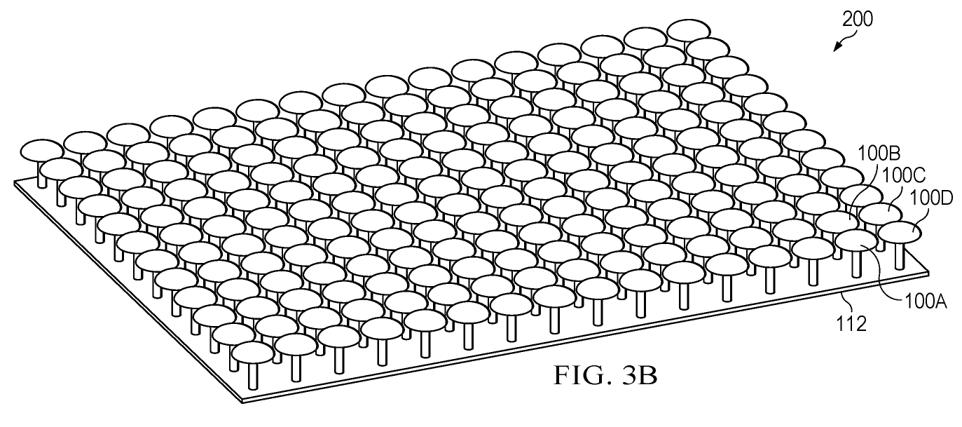

FIGS. 3A and 3B show an embodiment of the retaining cell 200 with the retaining members 100 arranged in a square grid layout. The retaining cell 200 may be formed or manufactured as “sheets” with two or more retaining members 100 extending from the support base 112. In an embodiment, FIGS. 3A and 3B show the retaining cell 200 as a rectangular sheet formed with the retaining members 100 arranged in a repeating adjacent square grid layout as shown with retaining members 100A-D.

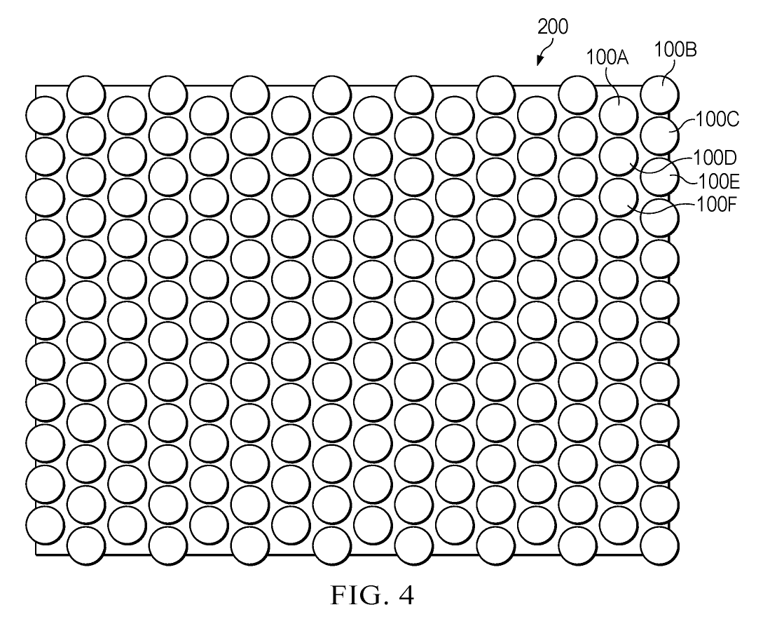

FIG. 4 shows an embodiment of the retaining cell 200 as a rectangular sheet formed with the retaining members 100 arranged in adjacent repeating complementary triangular grid layouts as shown with retaining members 100A-C as one triangular arrangement adjacent to retaining members 100D-F in a complementary triangular arrangement. In the triangular grid layout, each column of the retaining members 100 on the support base 112 may be positioned offset from adjacent retaining members 100 in each adjacent row of retaining members 100. In the embodiment shown, retaining member 100A, 100D, and 100F in one column on the support base 1112 may therefore be positioned offset from adjacent retaining members 100B, 100C, and 100E in an adjacent column of retaining members 100..

The varying arrangements of the retaining members 100 in the retaining cell 200 and the use of multiple retaining cells 200 with different arrangements of retaining members 100 may provide flexible options for the management and routing of the wire 300, including managing wires 300 that cross, curve, and/or route in different directions.

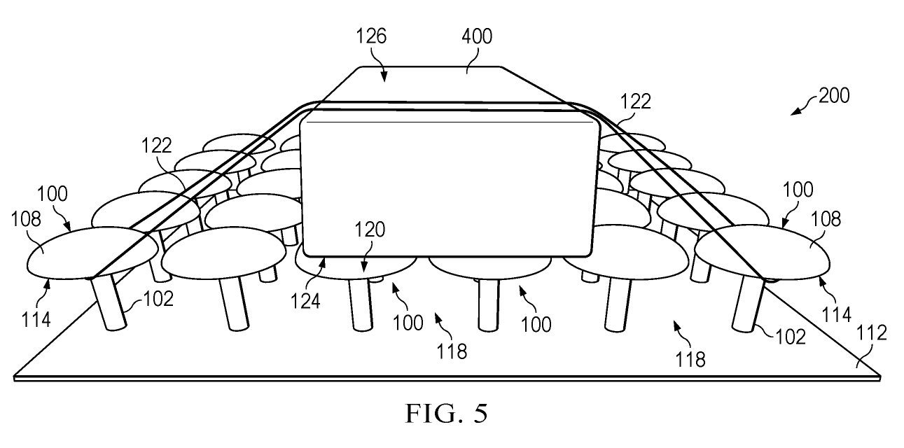

Turning to FIG. 5, the retaining cell 200 on the support base 112 may be used to support and hold a device 400. Adjacent retaining members 100 in the retaining cell 200 may cooperate to support the device 400 against top surface 120 of the respective caps 108 of the adjacent retaining members 100. The device 400 may then be secured against the retaining cell 200 by a securing strap 122.

As shown in FIG. 5, the top surface 120 of retaining members 100 may formed with a suitable surface to provide stability and support a bottom surface 124 of the device 400. The bottom surface 124 of the device 400 may be positioned directly against the top surface 120 of the retaining members 100 in the retaining cell 200 and be supported by respective retaining members 100 the device 400 is in contact with in the retaining cell 200. To secure the device 400 against the supporting members 100 in the retaining cell 200, the securing strap 122 may be extended over a top surface 126 of the device 400 and affixed to retaining members 100 supporting the device 400 or other retaining members 100 in the retaining cell 200 not supporting the device 400.

In an embodiment, the securing strap 122 may be affixed to individual retaining members 100 in the retaining cell 200. In another embodiment, the securing strap 122 may be affixed to more than one retaining members 100. The example in FIG. 5 shows the securing strap 122 affixed to individual retaining members 100 in the retaining cell 200 not being used to support the device 400. In yet another alternative embodiment, the securing strap 122 may affixed to or wrapped around extending members, hooks, pegs, and the like secured to or extending from the support base 112.

When securing the device 400 to the retaining cell 200, the securing strap may exert a force on the device 400 to push the device 400 towards the top surface 120 of the respective caps 108 supporting the device 400. The compression of the device 400 against the caps 108 of the retaining members 100 by the securing strap 122 may secure the device 400 to the retaining cell 200. As shown in FIG. 5, in an embodiment, the securing strap 122 may comprise an elastic loop such as a rubber band for securing the device 400. The elastic securing strap 122 may be stretched to exert a force on the device 400.

To secure the device 400 to the retaining cell 200, the body of the securing strap 122 may extend across the top surface 126 of the device 400 and towards the retaining members 100 on opposite sides of the device 400. The ends of the securing strap 122 may then be looped over at least one of the caps 108 of the retaining member 100 positioned on opposite sides of the device 400 to maintain the stretched position of the securing strap 122. The securing strap 122 may be looped over the retaining members 100 by fitting the securing strap 122 through the cap space 116 of each of the retaining member 100 on the side of the retaining member 100 opposite and away from the device 400. The looped retaining members 100 may hold the stretched position of the securing strap 122 at the attachment point between the respective stem 102 and the bottom surface 114 of the cap 108 of the respective looped retaining members 100.

In an embodiment, the securing strap 122 may alternatively comprise clamps, belts, latches, securing links, and the like that may be used in addition or as alternatives to the elastic loop band shown in FIG. 5. In an embodiment, more than one securing strap 122 may also be used to secure different portions of the device 400 to the retaining cell 200.

In an embodiment, the device 400 that may be supported and held by the retaining cell 200 may include power strips, electronic enclosures, computer peripherals, power banks, external hard drives, computer accessories, and the like. When an electronic computer device or peripheral is secured to the retaining cell 200, the channel space 118 between the retaining members 100 in the retaining cell 200 supporting the associated electronic computer device or peripheral may provide air cooling pathways and/or ventilation to the retained device 400.

In alternative embodiments, the retaining member 100 may comprise a variety of shapes and sizes. The size of the cap space 116 between adjacent caps 108 may be varied including being substantially none.

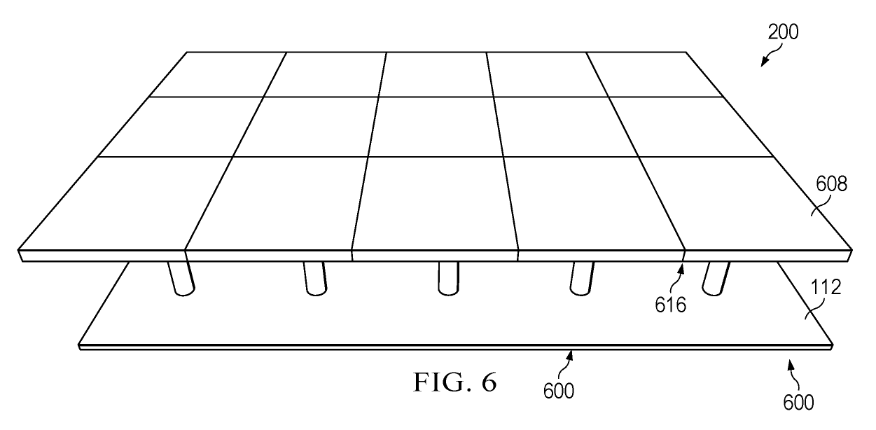

FIG. 6 shows an alternative embodiment of the retaining cell 200 with a retaining member 600 being formed on the support base 112 with a cap 608 having a rectangular perimeter shape. In the embodiment shown, the edges of the perimeter of the caps 608 of adjacent retaining members 600 may virtually be in direct contact with one another such that the cap space 616 between adjacent retaining members 600 may be minimal to none. In an embodiment, the caps 608 of the plurality of retaining members 600 may be formed from the same cut of a sheet of material forming the adjacent caps 608.

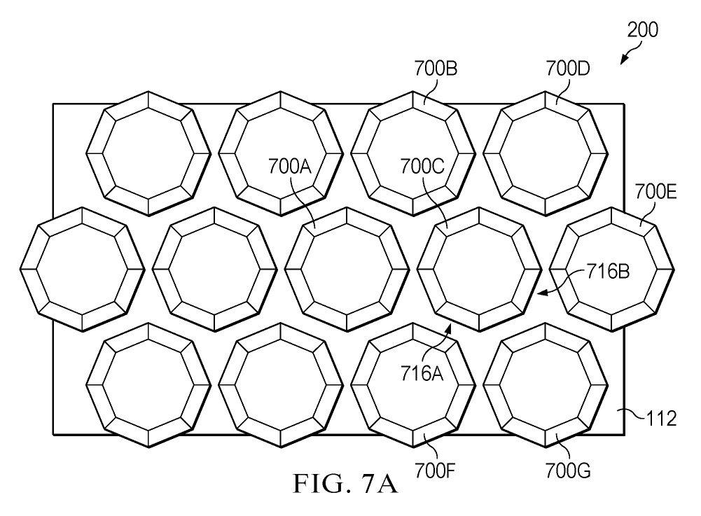

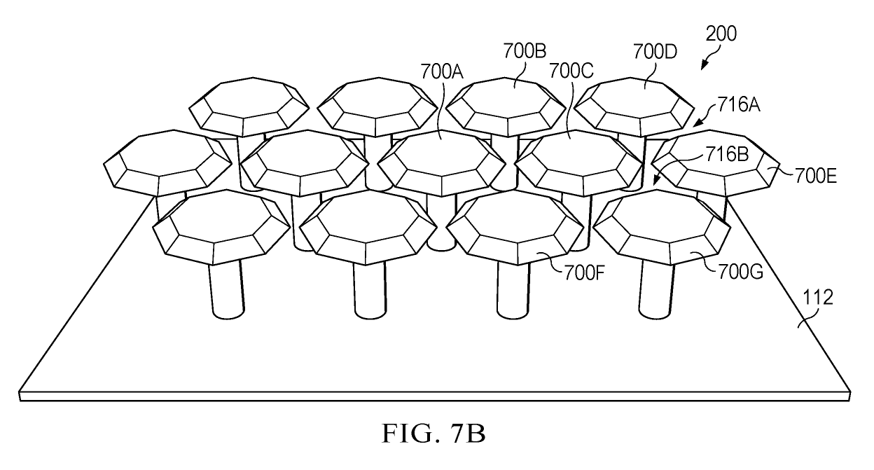

FIGS. 7A and 7B show an alternative embodiment of the retaining cell 200 with a retaining member 700 being formed with a cap 708 having an octagonal perimeter shape. In the embodiment shown, the retaining cell 200 may be formed by arranging the octagonal retaining members 700 in a staggered or hexagonal grid arrangement.

As shown in FIG. 7A, the hexagonal grid arrangement of the retaining members 700A-G with the octagonal shaped caps 708 may provide the retaining cell 200 with different cap spacings at different portions of the caps 708 between adjacent retaining members 700. In the embodiment shown, the arrangement and shape of the retaining members 700A-G may provide the retaining cell 200 with a smaller cap space 716A as well as a larger cap space 716B between the various adjacent octagonal retaining members 700A-G. In the embodiment shown, the smaller cap space 716A may be formed between parallel edges of the caps 708 between adjacent retaining members 700 positioned diagonally from one another, as shown between retaining members 700A and 700B, and retaining members 700C and 700D. Corners of adjacent hexagonally shaped caps 708 may also be oriented proximally to each other, to provide less contact area and less frictional resistance to passing a wire, for example, between the corners into the channel between the associated retaining members 700. The corners being spaced farther from the center of the retaining members 700 also provides more leverage to resiliently bend the associated members 700 and displace the caps 708 to facilitate allowing passage of a wire or other conduit in between the adjacent retaining members 700.

The larger cap space 716B may be formed in a space created at middle of the edges of the caps 708 of each set of three adjacent retaining members 700 positioned in a triangular layout in a quadrant of the hexagonal grid arrangement. As shown in FIG. 7A, the larger cap space 716B may be formed between adjacent retaining members 700A-C positioned in a triangular layout in the upper left quadrant of the hexagonal grid arrangement of retaining members 700A-G. In the embodiment shown, another larger cap space 716B may similarly be formed between adjacent retaining members 700C, 700E, and 700G positioned in a triangular layout in the lower right quadrant of the hexagonal grid arrangement of retaining members 700A-G. The different cap spaces 716A and 716B may assist in the holding and routing of the wire 300 of varying sizes and numbers by utilizing the larger cap space 716B for areas with larger cables or where multiple wires 300 may cross or bend.

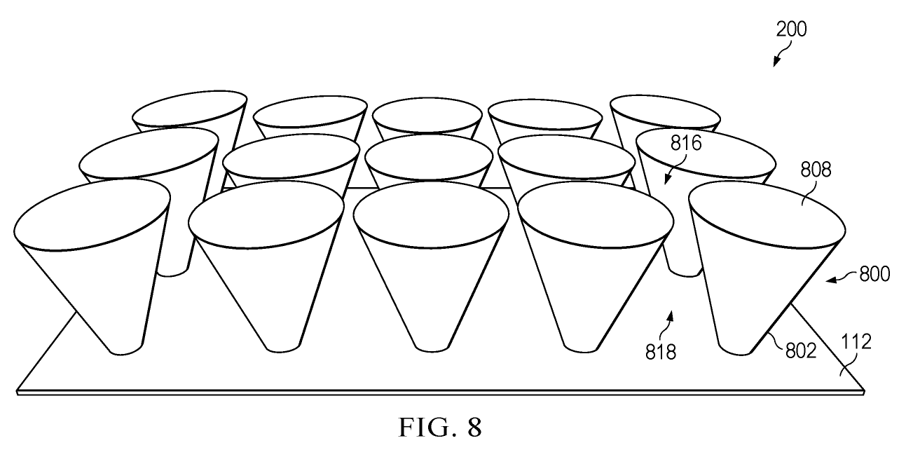

FIG. 8 shows an alternative embodiment of the retaining cell 200 with a retaining member 800 being formed with a stem 802 and a cap 808 having a unitary inverted conical shape. In the embodiment shown, the stem 802 may be flexible and formed with an increasing thickness from the support base 112 to the cap 808. The varying thickness of the stem 802 in the retaining member 800 necessarily creates a channel space 818 with varying sizing as well. The channel space 818 may inversely decrease in width from the support base 112 to the cap space 816 as the stem 802 increases in thickness towards the caps 808. The stem 802 and cap 808 may be formed as unitary inverted conical structure such that a distal end 806 of the stem 802 coincides with a top surface 820 of the cap 808.

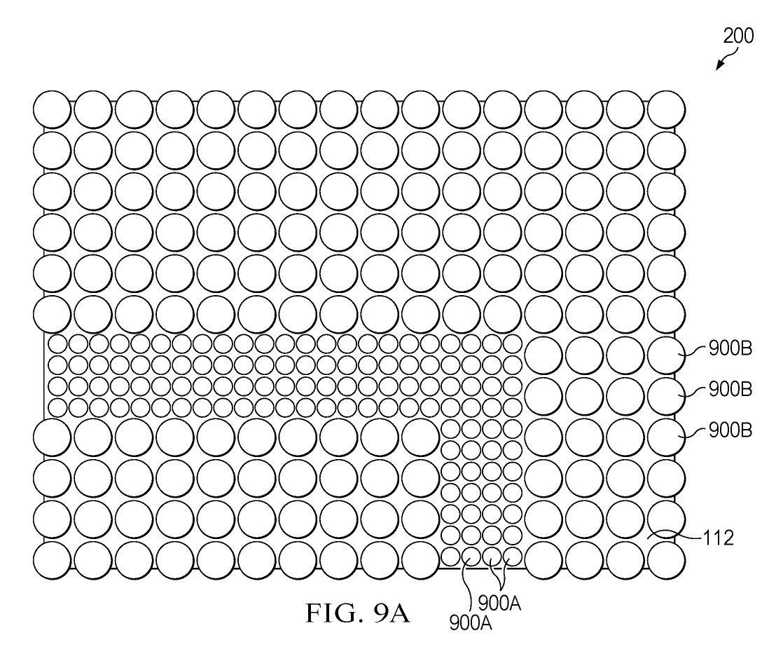

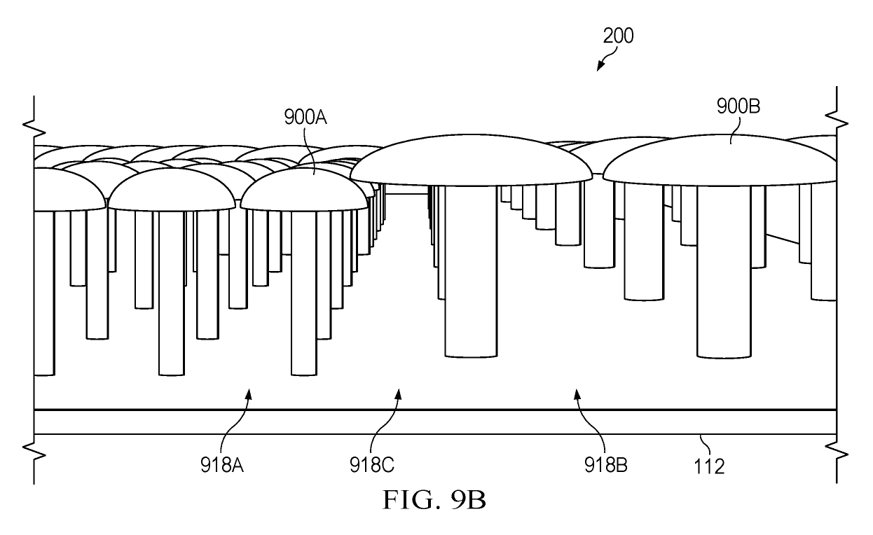

In an embodiment, a single sheet of the retaining cell 200 may also be formed with retaining members 100 of varying sizes arranged adjacent to one another on the support base 112. FIGS. 9A and 9B show an embodiment of the retaining cell 200 with both a small retaining member 900A and a large retaining members 900B extending from the support base 112. The different sized retaining members 900A, 900B may allow a single sheet of the retaining cell 200 to be formed with both a smaller channel space 918A and a larger channel space 918B for the holding of different sized wire 300s on a single sheet of retaining cell 200.

As shown in FIG. 9B, a small cap space 916A may be formed between adjacent small retaining members 900A, a large cap space 916B may be formed between adjacent large retaining members 900B, and a transition cap space 916C may be formed between the small and large retaining members 900A, 900B that are adjacent to one another. Small and large retaining members 900A, 900B may also from a transition channel space 918C. The different sized channel spaces 918A, 918B, 918C may allow for the holding and routing of different sized wires 300. As an example, the large channel spaces 918B, 918C may be used to hold and route larger cables, such as power cords, HDMI cables, parallels, cables, etc. The small channel space 918B may be used to hold and route smaller cables such as speaker cables, USB cables, Cat6E Ethernet cables, etc.

In an embodiment, the support base 112 may further comprise a plurality of score marks 132 to facilitate cutting of the sheet of retaining cell 200 to a desired custom shape and size. The score marks 132 may decrease the effort necessary to cut straight or curved lines to prepare the retaining cell 200 into a custom shape desired by the user.

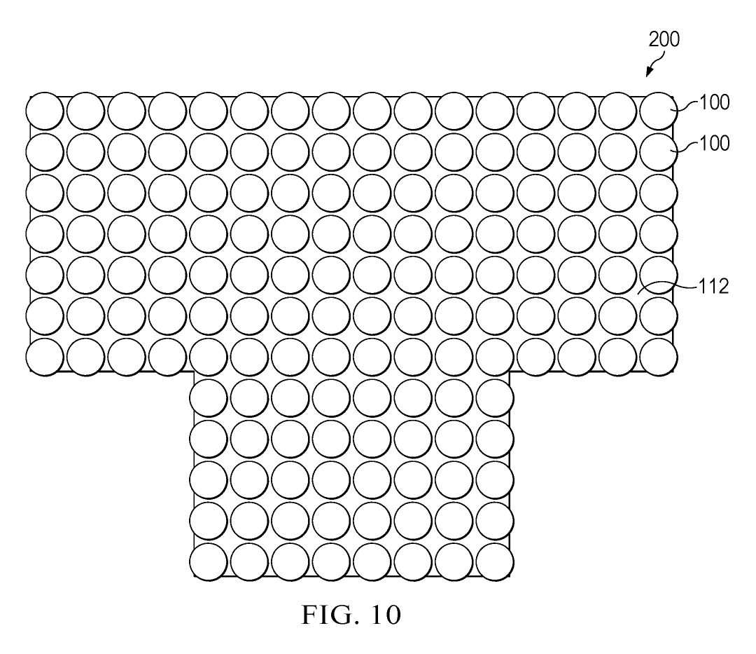

FIG. 10 an example of the retaining cell 200 originally in a square shape as shown in FIG. 3A prepared and cut into a custom “T” shape. Various embodiments may be configured as may be desired by the user cutting the sheet of retaining cell 200 for a variety of differently shaped or configured desks, entertainment centers, electronics racks, computer cases, work setups, and the like or as the user may desire.

In an embodiment, the support base 112 may further comprise a mounting surface 128 on the back side of the support base 112 opposite from the support surface 110 of the support base 112. The mounting surface 128 may further comprise a mount 130 to install and mount the support base 112 and thereby the retaining cell 200 on another surface. The mount 130 may be formed on the support base 122 for peel and stick applications. In an embodiment, the mount 130 may be used to mount secure the retaining cell 200 on the underside, topside, or backside of a desk, the backside of an entertainment center, the wall of a server rack, or any other surface in an environment where cables may be used or routed. The retaining cell 200 may be used in any environment where cables may be set into the channel space 118 between the retaining members 100 of the mounted retaining cell 200 and subsequently held out of the way.

In an embodiment, the mount 130 may comprise a double-sided adhesive tape for securing the support base 112 to another surface. Alternatively, other forms of mounting devices that may be used for the mount 130 may include but is not limited to magnets, hook and loop fasteners, adhesive strips, adhesives, glue, and the like.

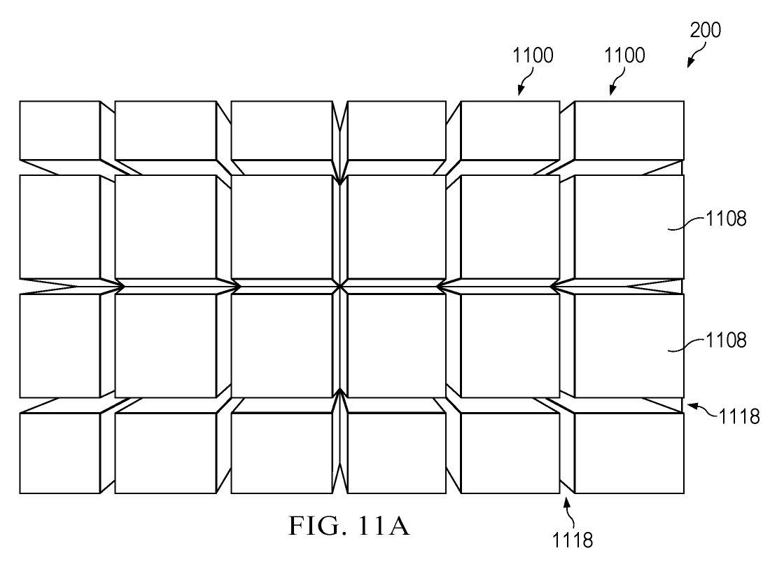

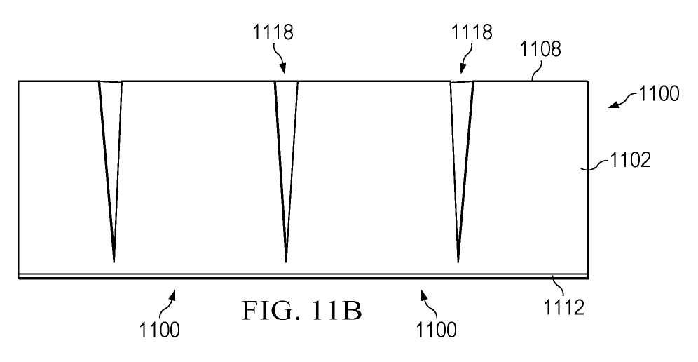

FIGS. 11A and 11B show an embodiment of a retaining cell 200 with a plurality of retaining members 1100 formed from an elastomeric block. As shown in FIGS. 11A and 11B, a support base 1112, a stem 1102, and a cap 1108 may be formed by making one or more cuts in the block. In an embodiment, the one or more cuts may be a series of two or more diagonal wedge cuts that may allow a resulting wedge portion of the block to be removed. The wedge cuts in the 1104 may form each of the retaining members 1100 through the remaining material left in the block after the wedge cut portions of the block are removed. In the embodiment shown in FIG. 11A, crossing wedge cuts are made across the entire block in a grid arrangement. Crossing cuts form intersecting retaining channels through which one or more wires may be placed and secured. The removal of the wedge cut portions of the block may also simultaneously create and leave a channel space 1118 in between each of the formed retaining members 1100 in the block. As shown in FIG. 11B, the channel space 1118 may similarly resemble a wedge shaped cut with the size of the channel space 1118 increasing from the support base 1112 towards the cap 1108 of adjacent retaining members 1100 on opposite sides of the channel space 1118..

In an embodiment, the elastomeric block may be formed from materials that may exhibit elastomeric and resilient properties. The use of an elastomeric block may allow the retaining members 1100 formed in the block to exhibit the same elastomeric and resilient properties. In order for the retaining members 1100 to hold the wire 300, the wire 300 may be pressed into and embedded within the channel space 1118 between the retaining members 1100 towards the support base 1112. When embedded within the channel space 1118, the wire 300 may be in direct contact with the oppositely facing sidewalls of adjacent retaining members 1100 on opposite sides of the channel space 1118. One or both of the oppositely facing sidewalls may resiliently deflect away from the other sidewall forming the channel space 1118 to allow insertion of a wire into the channel space 1118. The wire 300 may therefore be held within the channel space 1118 using elastomeric pressure from the retaining members 1100 forming the specific channel space 1118 against the embedded wire 300. The elastomeric pressure may be applied by the sidewalls of the members 1100 against both the lateral and top sides of the wire embedded into the channel space 1118. The resilient expansion of the sidewalls against the embedded wire thus may both frictionally grip the wire laterally and interfering with removal of the wire by overlapping the top of the wire within the channel space 1118.

Alternatively, in an embodiment, straight cuts may be made directly into the elastomeric block to form the channel space 1118 without portions of the block removed. To hold the wire 300, the wire 300 may be embedded into the slit openings created by the straight cuts in the elastomeric block.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

We claim:

1. An apparatus for securing one or more wires, comprising:
a support base having a support surface;
a plurality of retaining members extending outwardly from the support surface of the support base, wherein each of the plurality of retaining members are spaced apart on the support base;
each of the plurality of retaining members having a stem, wherein each stem has a longitudinal length extending between a proximal end and a distal end of the stem;
wherein each stem is secured at the proximal end to the support surface of the support base;
wherein the distal end of each stem further comprises at least a securing portion that extends radially outwardly a distance greater than the proximal end of each stem;
wherein the securing portion of at least one retaining member extends radially outwardly toward the securing portion of the other of the plurality of retaining members;
wherein a retaining cell for securing one or more wires is formed by at least a portion of the longitudinal lengths of the stems of the plurality of retaining members extending outwardly from the support surface, the support surface between the plurality of retaining members, and the securing portion of the at least one retaining member;
wherein the securing portion of the at least one retaining member is configured to resiliently deflect away from the other of the plurality of retaining members and bend towards the support surface to allow insertion of a portion of a length of wire into the retaining cell; and
wherein the securing portion of the at least one retaining member is configured to resiliently deflect away from the other of the plurality of retaining members and bend away from the support surface to allow withdrawal of a portion of wire from the retaining cell.

2. The apparatus of claim 1, wherein the securing portion of at least one of the plurality of retaining members extends radially outwardly from the distal end of the stem to form a circular perimeter surrounding the distal end.

3. The apparatus of claim 1, wherein the securing portion of at least one of the plurality of retaining members extends radially outwardly from the distal end of the stem to form a mushroom-cap shape with a curved perimeter surrounding the distal end.

4. The apparatus of claim 1, wherein the securing portion of at least one of the plurality of retaining members extends radially outwardly from the distal end of the stem to form a circular perimeter surrounding the distal end and having a convex surface facing away from the support surface.

5. The apparatus of claim 1, wherein the securing portion of at least one of the plurality of retaining members extends radially outwardly from the distal end of the stem to form a polygonal perimeter surrounding the distal end.

36. The apparatus of claim 5, wherein the securing portion of each of the plurality of retaining members extends radially outward toward the securing portion of the other of the plurality of retaining members to form a rectangular perimeter; and
wherein adjacent edges of the securing portions of the plurality of retaining members are substantially parallel and formed from the same cut in a sheet of material forming the adjacent edges of the securing portions.

7. The apparatus of claim 1, wherein the stem of at least one of the plurality of retaining members is conically shaped and wherein the proximal end is relatively narrow, and the distal end is relatively wide.

8. The apparatus of claim 1, wherein the support base further comprises a mount configured to secure the support base to another surface.

9. The apparatus of claim 1, wherein at least a portion of the proximal end of the each stem extending from the support base further comprises a fillet.

10. The apparatus of claim 1, wherein at least a portion of the distal end of each stem forming the at least one securing portion further comprises a fillet.

11. The apparatus of claim 1, wherein four or more of the retaining members extending from the support base are positioned on the support base in a square grid arrangement, a triangular grid arrangement, and/or a hexagonal grid arrangement.

12. The apparatus of claim 1, wherein one or both of the securing portion of the of the plurality of retaining members and the plurality of retaining members further comprises rubber, acrylic, polycarbonate, high-density polyethylene, high-density polyethylene, plastic, acrylonitrile butadiene styrene (ABS) plastic, thermoplastic elastomers, thermoplastic polyurethanes, elastic resin, or other elastic material.

13. The apparatus of claim 1, wherein the support base further comprises one or more perforated edges.

14. The apparatus of claim 1, wherein support base further comprises a planar, grooved, undulating, mesh, or tiered structure.

15. The apparatus of claim 1, further comprising a space between adjacent edges of the securing portions of the plurality of retaining members, wherein the space between each of plurality of retaining members immediately adjacent to one another on the support base are substantially the same.

16. The apparatus of claim 1, further comprising a space between adjacent longitudinal lengths of the stems of the plurality of retaining members, wherein the space between each of the plurality of retaining members immediately adjacent to one another on the support base are substantially the same.

17. The apparatus of claim 1, wherein the longitudinal length of at least one of the stems of the plurality of retaining members is different from the longitudinal length of the stems of the other of the plurality of retaining members.

18. The apparatus of claim 1, wherein the radially outward extension of the securing portion from the distal end of at least one of the plurality of retaining members is different from the radially outward extension of the securing portion from the distal end of the other of the plurality of retaining members.

19. The apparatus of claim 1, wherein the stem of the plurality of retaining members is flexible, and wherein at least a portion of each stem of the plurality of retaining members is configured to apply a compressive force against one or more wires positioned between the stems of the plurality of retaining members immediately adjacent to one another on the support base.

20. The apparatus of claim 1, further comprising:
one or more retaining straps;
a first anchor extending from the support base; and
a second anchor extending from the support base;
wherein the one or more restraining straps is configured to affix to the first and second anchor extending from the support base to secure an enclosure device placed on the plurality of retaining members between the one or more restraining and the plurality of retaining members extending from the support base; and
wherein the plurality of retaining members extending between the support base and the enclosure device is configured to provide ventilation and air pathways between the support base and the securing portion of the plurality of retaining members..

21. The apparatus of claim 20, wherein the first and second anchors each further comprise at least one of the plurality of retaining members extending from the support base.

22. An apparatus for arranging and containing a wire, comprising:
a planar base;
two or more wire retaining members;
wherein each wire retaining member further comprises a stem having a proximal end secured to the planar base against relative movement and the stem extending from the proximal end to a distal end;
two or more flexible caps, wherein each of the two or more caps are disposed at the distal end of each one of the two or more stems;
wherein each flexible cap extends laterally from the distal end of the respective stem;
wherein the two or more flexible caps immediately adjacent to each other each extend outwardly from the respective distal end of each stem towards one another;
wherein at least a portion of two of the caps immediately adjacent each other are configured to be displaced from a first position to a second position toward the planar base in response to a displacing force applied by a wire urged between the immediately adjacent caps; and
wherein the caps are configured to resiliently return to the first position following passage of the wire past the caps toward the planar base.

23. The apparatus of claim 22, wherein at least one of the flexible caps of the two or more wire retaining members extends radially outwardly from the distal end of the stem to form a circular perimeter or a polygonal perimeter bordering the distal end.

24. The apparatus of claim 22, wherein at least one of the flexible caps of the two or more wire retaining members extends radially outwardly from the distal end of the stem to form a circular perimeter surrounding the distal end and having a convex surface facing away from the support surface.

25. The apparatus of claim 22, wherein four or more of the wire retaining members are positioned in a square grid arrangement, a triangular grid arrangement, or an hexagonal grid arrangement on the planar base.

26. The apparatus of claim 22, further comprising a space between adjacent edges of the caps of the two or more wire retaining members, wherein the space between the caps of each of the two or more wire retaining members immediately adjacent to each other on the planar base are substantially the same.

27. The apparatus of claim 22, further comprising a space between the stems of two or more wire retaining members, wherein the space between each of the two or more wire retaining members immediately adjacent to each other on the planar base are substantially the same.

28. The apparatus of claim 22, wherein the planar base further comprises one or more perforated edges.

29. The apparatus of claim 22, wherein the flexible stem of each of the two or more wire retaining members are conically shaped and wherein the proximal end of the flexible stem is narrower when compared to the cap at the distal end.

30. The apparatus of claim 22, wherein at least one of the flexible stems of the two or more wire retaining members is relatively shorter than the other flexible stem of the two or more wire retaining members.
